(19) United States
(12) Patent Application Publication
(10) Pub. No.: US 2008/0289461 A1
(43) Pub. Date: Nov. 27, 2008

(54) Torque Wrenches

(76) Inventor: Paul Anthony Anson, Staffordshire (GB)

Correspondence Address: NIXON & VANDERHYE, PC, 901 NORTH GLEBE ROAD, 11TH FLOOR, ARLINGTON, VA, 22203, US

(21) Appl. No.: 12/125,547

(22) Filed: May 22, 2008

(30) Foreign Application Priority Data
May 26, 2007 (GB) 0710170.2

(51) Int. Cl. B25B 23/14; B25B 23/00

(52) U.S. Cl. 81/467; 81/57.44

(57) ABSTRACT

The piston 32 and cylinder 30 of a torque wrench 18 are provided with pressurised fluid from a source 12 through an advance port 16, or from a pump 42 through a return port 38. The source 12 includes a large piston 26 driven from the pump 42 during the advance stroke, and a small piston 22 driving fluid to the advance port 46, or receiving fluid returned from the port 16, during the return stroke. Accordingly, the pistons 22 and 32 form a closed system for fluid moving between the cylinder 24 and the cylinder 30. The pistons 22, 26 are connected by a shaft 68 so that relatively low pressure applied to the piston 26 results in high pressure fluid delivered to the advance port 16. Consequently, a low pressure pump 42 can be used to provide high pressure drive via the source 12, or a low pressure return stroke via the return port 38.

The present invention relates to torque wrenches and in particular, to apparatus for supplying pressurised fluid for operation of powered torque wrenches.

In one aspect, embodiments of the invention provide apparatus comprising:

a source of pressurised fluid;

an outlet for supplying pressurised fluid from the source to a torque wrench to drive an action of the wrench;

wherein the source comprises a first piston and a first cylinder and the first piston is operable to deliver a predetermined volume of pressurised fluid for each action of the wrench, and wherein the first cylinder is operable to receive fluid returned from the torque wrench, between deliveries to provide, with the wrench, a closed system for the pressurised fluid.

The permitted stroke length of the first piston may be set to determine the predetermined quantity. Limit means may be provided to detect the first piston reaching a stroke limit. Limit means may be provided to detect the first piston reaching two stroke limits defining a stroke length. The first piston may have an advance stroke delivering fluid to the wrench, and a return stroke receiving fluid from the wrench.

The first piston may be mechanically coupled to a second piston in a second cylinder, to be driven by movement of the second piston. The hydraulic area of the second piston may differ from the hydraulic area of the first piston, whereby the first piston, in use, delivers fluid at a pressure which differs from the pressure applied to the second piston.

The hydraulic area of the first piston may be smaller than the hydraulic area of the second piston, whereby the first piston, in use, delivers fluid at a higher pressure than the pressure applied to the second piston.

Alternatively, the hydraulic area of the first piston may be larger than the hydraulic area of the second piston, whereby the first piston, in use, delivers fluid at a lower pressure than the pressure applied to the second piston.

The apparatus may further comprise a second source of pressurised fluid, operable to drive the second piston. The second source may be selectively operable to drive the second piston or to provide fluid to the torque wrench, whereby the sources create an advance action and a return stroke of the torque wrench.

The first source may supply pressurised fluid to an advance port of the wrench to drive an advance action of the wrench. The second source may supply pressurised fluid to a return port of the wrench, to drive a return stroke of the wrench.

Alternatively, the first source may supply pressurised fluid to a return port of the wrench, to drive a return stroke of the wrench. The second source may supply pressurised fluid to an advance port of the wrench, to drive an advance action of the wrench.

In another aspect, embodiments of the invention provide apparatus comprising:

a first source of pressurised fluid;

an outlet for supplying pressurised fluid from the source to a torque wrench to drive an action of the wrench;

wherein the first source comprises a first piston in a first cylinder and mechanically coupled to a second piston in a second cylinder to be driven by movement of the second piston, the hydraulic areas of the first and second pistons being different, whereby the first piston, in use, delivers fluid at a pressure which differs from the pressure applied to the second piston.

The hydraulic area of the first piston may be smaller than the hydraulic area of the second piston, whereby the first piston, in use, delivers fluid at a higher pressure than the pressure applied to the second piston.

Alternatively, the hydraulic area of the first piston may be larger than the hydraulic area of the second piston, whereby the first piston, in use, delivers fluid at a lower pressure than the pressure applied to the second piston.

There may be a second source of pressurised fluid, operable to drive the second piston. The second source may be selectively operable to drive the second piston or to provide fluid to the torque wrench, whereby the sources create an advance action and a return stroke of the torque wrench.

The first source may supply pressurised fluid to an advance port of the wrench to drive an advance action of the wrench. The second source may supply pressurised fluid to a return port of the wrench, to drive a return stroke of the wrench.

Alternatively, the first source may supply pressurised fluid to a return port of the wrench, to drive a return stroke of the wrench. The second source may supply pressurised fluid to an advance port of the wrench, to drive an advance action of the wrench.

The source may be operable to deliver pressurised fluid until a predetermined quantity has been delivered and thereafter to stop delivering until a subsequent action is required. The source may be operable to receive fluid returned from a torque wrench, between deliveries. The source may provide, with the wrench, a closed system for the pressurised fluid.

The first piston may have a permitted stroke length set to determine the predetermined quantity. Limit means may be provided to detect the first piston reaching a stroke limit. Limit means may be provided to detect the first piston reaching two stroke limits defining a stroke length. The first piston may have an advance stroke delivering fluid to the wrench, and a return stroke receiving fluid from the wrench.

Examples of the present invention will now be described in more detail, by way of example only, and with reference to the accompanying drawings, in which:

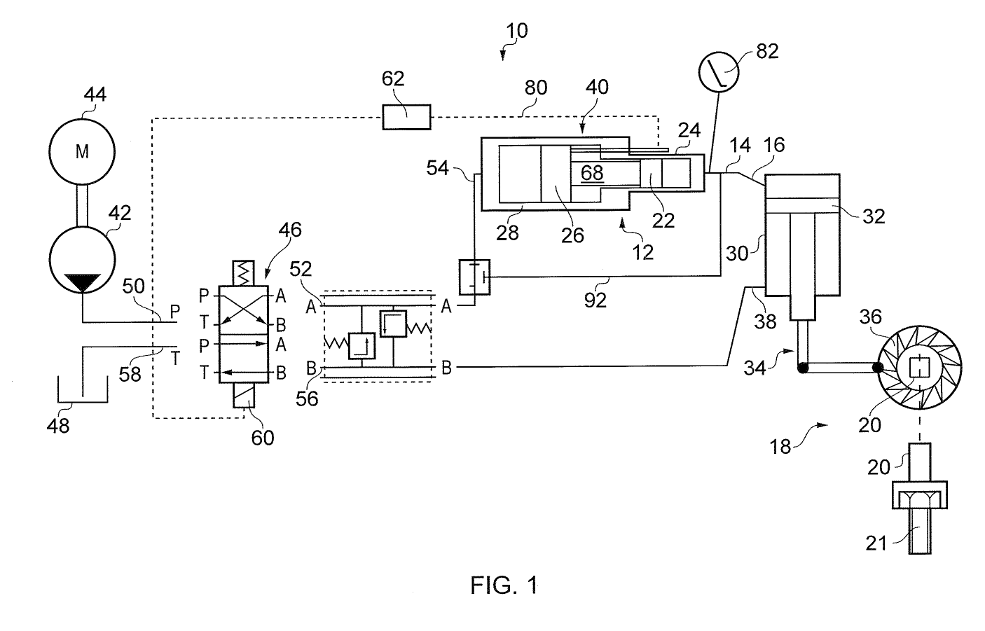

FIG. 1 is a schematic diagram of apparatus supplying pressurised fluid to a torque wrench;

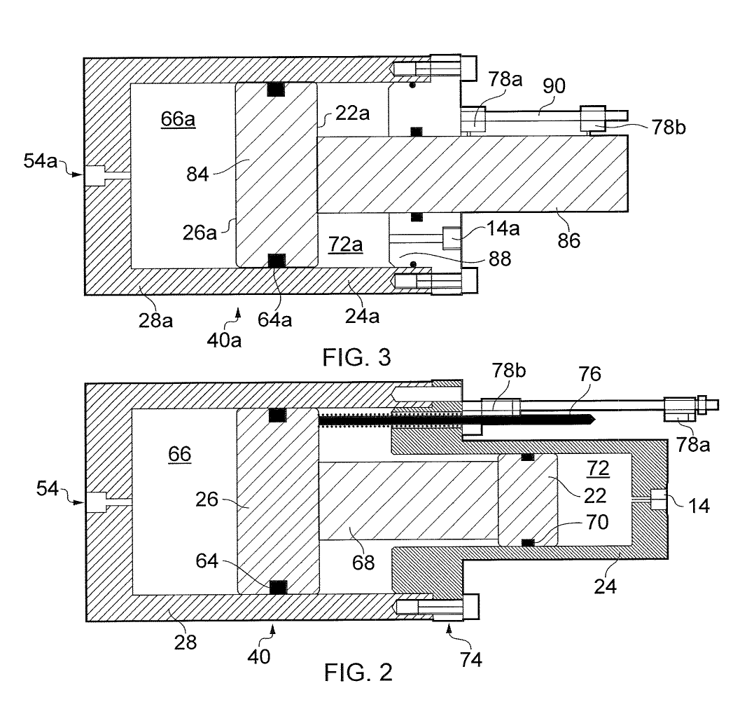

FIGS. 2 and 3 are schematic cross-sections of alternative intensifier units for use with the apparatus of FIG. 1; and

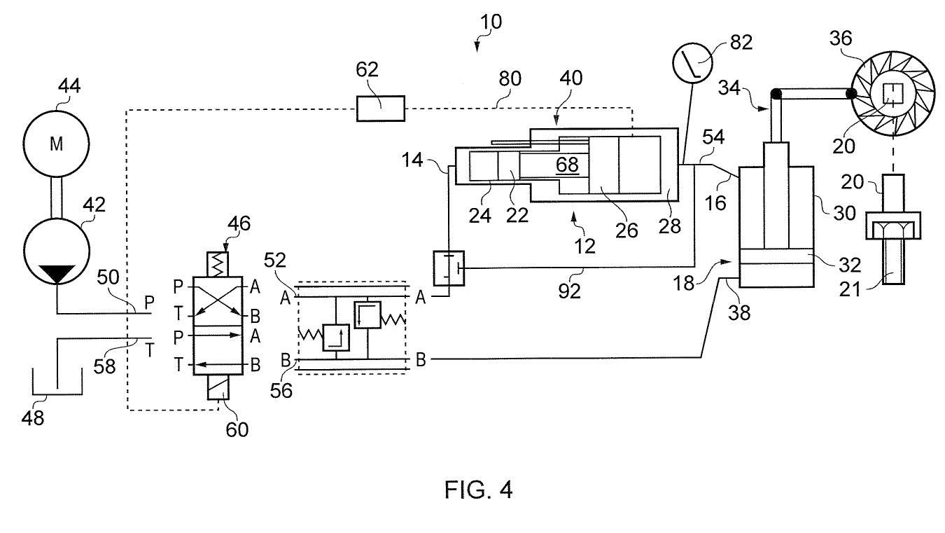

FIG. 4 corresponds with FIG. 1, with the intensifier unit reversed for use with a high pressure supply.

FIG. 1 illustrates apparatus 10 comprising a source of pressurised fluid, indicated generally at 12. The apparatus 10 has an outlet 14 for supplying pressurised fluid from the source 12 to a port 16 of a torque wrench indicated generally at 18. In this example, the port 16 is the advance port of the wrench 18. Pressurised fluid, through the advance port 16, drives an advance action of the wrench 18. For example, the advance action causes a rod and socket member 20 of the wrench 18 to turn, so that a threaded member 21 in the socket of the member 20 is thereby tightened or slackened, according to the sense of rotation.

In the example to be described, the source 12 is operable to deliver pressurised fluid until a predetermined quantity has been delivered to the advance port 16. Thereafter, the source 12 stops delivery until a subsequent advance action is required. In this example, the source comprises a first piston 22 in a first cylinder 24. The first piston 22 is mechanically coupled to a second piston 26 in a second cylinder 28. Movement of the first piston 22 is driven by movement of the second piston 26. As will be described more fully below, the hydraulic area of the second piston 26 is greater in this example than the hydraulic area of the first piston 22, whereby the first piston 22, in use, delivers fluid at a higher pressure than the pressure applied to the second piston 26.

In more detail, the wrench 18 has a hydraulic cylinder 30 containing a double acting piston 32. The piston 32 is mechanically coupled (schematically indicated at 34) to the rod and socket member 20 of the wrench 18, so that movement of the piston 32 causes the member 20 to turn, either in a first direction representing an advance stroke which tightens the threaded member 21 held by the wrench, or a return stroke. The coupling 34 incorporates a ratchet arrangement 36. Accordingly, each advance stroke further tightens the threaded member 21 and therefore requires relatively high torque. Each return stroke requires relatively little torque, sufficient to move the coupling 34 past the ratchet 36.

The advance port 16 supplies the wrench cylinder 30 on one face of the piston 32 allowing pressurised fluid supplied through the port 16 to drive an advance action of the wrench 18. The other side of the piston 32 is supplied through a return port 38 to drive the piston 32 in the opposite direction, to provide a return action.

The first and second pistons and cylinders, 22, 24, 26, 28 form an intensifier unit 40 supplied with hydraulic fluid from a pump 42 at low pressure (typically 250 bar, in one example). The pump 42 is driven by a motor 44, which may be driven electrically, pneumatically or by a petrol, diesel or gas internal combustion engine. The low pressure output of the pump 42 can be applied selectively to the intensifier unit 40 or to the return port 38. A valve 46 controls the connections between the pump 42 and the intensifier unit 40 and return port 38, and also connections to a reservoir 48. The valve 46 is a two position, four way valve indicated schematically in FIG. 1 in an intermediate position. In one working position of the valve 46, the pump 42 provides pressure at port 50 which is coupled through the valve 46 to port 52 and thence to the second cylinder 28 at 54. In this position of the valve 46, the return port 38 is coupled from port 56, through the valve 46, to the reservoir port 58 and thence to the reservoir 48.

In the alternative position of the valve 46, the ports 50, 58 are reversed with respect to the ports 52, 56, so that the low pressure supply from the pump 42 is supplied to the return port 38, and the port 54 of the second cylinder 28 is connected through to the reservoir 48.

The valve 46 is a solenoid operated valve in this example, having a solenoid 60 controlled from a control unit 62.

The example intensifier unit 40, illustrated simply in FIG. 1, is illustrated in more detail in FIG. 2 and will now be described.

The second piston 26 moves in the second cylinder 28, having appropriate seal rings 64 to provide a chamber 66 between the second piston 26 and the port 54. The piston 26 carries an axial shaft 68 on which the first piston 22 is formed to be movable in the first cylinder 24. Seal rings 70 are provided to form a sealed chamber 72 between the first piston 22 and the outlet 14. The cylinders 24, 28 are secured together at 74, for example by bolts or other fastenings.

The second piston 26 carries a control rod 76 parallel to the shaft 68, which passes out from the cylinders 24, 28 to extend alongside the cylinder 24, to move to and fro with the pistons 22, 26. Two sensors 78 are mounted alongside the cylinder 24 and are, in this example, electrical switches, micro switches, Hall effect devices or similar sensors. In use, when the pistons 22, 26 move to the right (as illustrated in FIG. 2), the rod 76 moves toward the sensor 78a until the tip of the rod 76 is sensed by the sensor 78a. Likewise, when the pistons 22, 26 move toward the left (as illustrated in FIG. 2), the sensor 78b detects the presence of the rod 76, until a point is reached at which the tip of the rod passes the sensor 78b, changing the state of the sensor 78b. Accordingly, the separation of the sensors 78 defines the distance between two points at which the tip of the control rod 76 will change the state of one or other sensor 78. These points are used as stroke limits defining a stroke length for the first piston 22. Having defined a stroke length for the piston 22, the volume of pressurised fluid delivered by the piston 22, through the outlet 14, will be predetermined according to the remaining, fixed geometry of the piston 22 and cylinder 24. The sensors 78a, 78b are adjustably mounted on a bar 79, to allow the predetermined volume to be changed.

Outputs from the sensors 78 are applied to the control unit 62, at 80 (FIG. 1), so that the position of the valve 46 can be changed whenever the sensors 78 detect the arrival of the piston 22 at a stroke limit.

Thus, for an advance stroke, the pump 42 supplies the port 54 driving the second piston 26 to the right (FIG. 2). This, in turn, pushes the first piston 22 to the right, expelling fluid from the outlet 14 to the advance port 16 and thus causing the piston 32 to move to effect an advance stroke of the wrench 18. When the sensor 78a senses the tip of the control rod 76, marking the stroke limit, the control unit 62 reverses the valve 46, so that the chamber 66 is vented, and the pump 42 supplies the return port 38, driving the piston 32 in the opposite direction, to effect a return stroke. As the piston 32 moves, pressurised fluid is forced back through the advance port 16 and outlet 14, into the chamber 72 of the first cylinder 24. Thus, the source 12 receives fluid returned from the wrench 18, between advance strokes and thus, the source 12 and cylinder 30 form a closed system for the fluid, between the pistons 22, 32.

In this example, a predetermined volume of pressurised fluid is delivered to the advance port 16, for each advance stroke, until the sensor 78a is triggered to end the advance stroke. The fluid is then returned to the first cylinder 24, on the return stroke. Delivering a predetermined volume of fluid on each advance stroke results in the length of each advance stroke of the wrench being the same.

During the advance stroke, the intensifier unit 40 receives low pressure hydraulic fluid through the port 54 and delivers hydraulic fluid through the outlet port 14. It is readily apparent from FIG. 2 that the cross-section of the second piston 26, exposed to fluid through the port 54, is larger than the cross-section of the first piston 22 driving fluid from the outlet 14. The surface area perpendicular to the axis of movement (here termed the “hydraulic area”) is therefore greater for the second piston 26 than for the first piston 22. Accordingly, the first piston 22 delivers hydraulic fluid through the outlet 14 at a pressure which is greater than the pressure with which hydraulic fluid is delivered to the second piston 26 through the port 54. The degree of pressure intensification depends on the ratio of hydraulic areas of the pistons 22, 26. For example, if the hydraulic area of the second piston 26 is three times the hydraulic area of the first piston 22, the hydraulic fluid will leave the outlet 14 at a pressure three times as great as the pressure received at the port 54.

Accordingly, the intensifier unit 40 results in delivery of relatively high pressure fluid to the advance port 16, but powered by the low pressure pump 42. This provides the necessary pressure to drive an advance stroke. For a return stroke, the low pressure delivered by the pump 42 is adequate and is thus applied directly to the return port 38, resulting in the wrench 18 executing a return action. Accordingly, both actions of the wrench 18 are driven by a single pump 42 which delivers low pressure fluid.

It may be desirable to incorporate pressure relief valves (illustrated in FIG. 1). In particular, a pressure relief valve 55 from the port 54 allows the pressure of an advance stroke to be limited, thus limiting the torque provided by the wrench 18, allowing an item to be tightened to a predetermined torque. The torque delivered by the wrench 18 may also be monitored by a pressure gauge 82 connected to the line from the outlet 14 to the advance port 16.

FIG. 3 illustrates an alternative form of intensifier unit, identified by numeral 40a. Many features correspond with those of the unit 40 of FIG. 2 and are given the same references, with the suffix a.

In the unit 40a, the pistons 22a, 26a are provided by opposite faces of the same piston element 84. Thus, they are directly connected together as faces of the element 84. A shaft 86 extends from the piston 22a, thus reducing its hydraulic area below that of the second piston 26a. The cylinders 24a, 28a are concentric extensions of each other and are closed at one end by a cap 88, through which the shaft 86 extends and through which the outlet port 14a communicates with the chamber 72a. Beyond the cap 88, sensors 78aa, 78ba are mounted on a bar 90. The sensors 78aa, 78ba sense the passing of the tip of the shaft 86, in a manner similar to the tip of the rod 76 being sensed in the arrangement of FIG. 2. Accordingly, the sensors 78aa, 78ab again set stroke limits for the first piston 22, so that a predetermined volume of pressurised fluid is delivered through the outlet 14, for each advance stroke of the wrench 18. The pressure at the outlet 14 is intensified relative to the inlet pressure at 54, by virtue of the smaller hydraulic area of the piston 22, as compared with the piston 26.

The arrangements described above have referred to a single hydraulic wrench 18 being supplied, but the arrangement can be used to supply multiple wrenches, if the volume delivered by a stroke of the piston 22, 22a is equal to or greater than the volume required to operate the sum of the wrenches being supplied.

In use, the pistons 22, 26 will repeatedly cycle to deliver relatively high pressure fluid to drive an advance action until the stroke limit is reached, and will then return before commencing a further advance action. This will continue until the setting of the pressure relief valve 55 (preferably adjustable) is reached, indicating that the predetermined torque limit has been reached.

In some circumstances, it may be convenient to provide a by-pass line 92 around the intensifier unit 40, 40a, allowing relatively fast, low pressure operation of the wrench 18. High pressure delivery from the outlet 14, 14a may be used without the return drive provided by the port 38, if other arrangements are provided for the return action.

The previous examples use a single source of relatively low pressure pressurised fluid, with the intensifier unit 40 being used to deliver high pressure to drive the advance action. In an alternative example, a single source of relatively high pressure pressurised fluid is used, as follows.

The unit 40, described above as an intensifier unit, can be used to reduce pressure, for example by reversing the unit 40, so that the port 54 is used to deliver to the wrench 30, and the port 14 is used to receive fluid from the pump 42. FIG. 4 illustrates the arrangement of FIG. 1, modified by reversing the intensifier unit 40. In this case, the fluid from the pump 42 is supplied to a second piston having a relatively small hydraulic area, and the supply to the wrench 30 is derived from a first piston having a relatively large hydraulic area. Accordingly, supply to the wrench 30 is at lower pressure than the output of the pump 42. Thus, by reversing the connections to the advance and return ports 16, 38, and replacing the pump 42 with a high pressure pump, this alternative arrangement allows the high pressure pump to deliver high pressure fluid directly to the wrench 30 to drive the advance action, and to cause the return stroke to be driven by relatively low pressure fluid, delivered from the reversed unit 40, which may now be termed a reducer unit.

The examples described above allow a torque wrench to be controlled to provide a predetermined torque from a single source of pressurised fluid. The use of a closed, high pressure system between the unit 40 and the wrench 30 allows the apparatus to cycle automatically until the torque limit set by the valve 46 is reached.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Apparatus comprising:
a source of pressurised fluid;
an outlet for supplying pressurised fluid from the source to a torque wrench to drive an action of the wrench;
wherein the source comprises a first piston and a first cylinder and the first piston is operable to deliver a predetermined volume of pressurised fluid for each action of the wrench, and wherein the first cylinder is operable to receive fluid returned from the torque wrench, between deliveries to provide, with the wrench, a closed system for the pressurised fluid.

2. Apparatus according to claim 1, wherein the permitted stroke length of the first piston is set to determine the predetermined quantity.

3. Apparatus according to claim 1, wherein limit means are provided to detect the first piston reaching a stroke limit.

4. Apparatus according to claim 3, wherein limit means are provided to detect the first piston reaching two stroke limits defining a stroke length.

5. Apparatus according to claim 1, wherein the first piston has an advance stroke delivering fluid to the wrench, and a return stroke receiving fluid from the wrench.

6. Apparatus according to claim 1, wherein the first piston is mechanically coupled to a second piston in a second cylinder, to be driven by movement of the second piston.

7. Apparatus according to claim 6, wherein the hydraulic area of the second piston differs from the hydraulic area of the first piston, whereby the first piston, in use, delivers fluid at a pressure which differs from the pressure applied to the second piston.

8. Apparatus according to claim 7, wherein the hydraulic area of the first piston is smaller than the hydraulic area of the second piston, whereby the first piston, in use, delivers fluid at a higher pressure than the pressure applied to the second piston.

9. Apparatus according to claim 7, wherein the hydraulic area of the first piston is larger than the hydraulic area of the second piston, whereby the first piston, in use, delivers fluid at a lower pressure than the pressure applied to the second piston.

10. Apparatus according to claim 6, wherein the apparatus further comprises a second source of pressurised fluid, operable to drive the second piston.

11. Apparatus according to claim 10, wherein the second source is selectively operable to drive the second piston or to provide fluid to the torque wrench, whereby the sources create an advance action and a return stroke of the torque wrench.

12. Apparatus according to claim 6, wherein the first source supplies pressurised fluid to an advance port of the wrench to drive an advance action of the wrench.

13. Apparatus according to claim 6, wherein the second source supplies pressurised fluid to a return port of the wrench, to drive a return stroke of the wrench.

14. Apparatus according to claim 6, wherein the first source supplies pressurised fluid to a return port of the wrench, to drive a return stroke of the wrench.

15. Apparatus according to claim 6, wherein the second source supplies pressurised fluid to an advance port of the wrench, to drive an advance action of the wrench.

16. Apparatus according to claim 14, wherein the second source supplies pressurised fluid to an advance port of the wrench, to drive an advance action of the wrench.

17. Apparatus comprising:
a first source of pressurised fluid;
an outlet for supplying pressurised fluid from the source to a torque wrench to drive an action of the wrench;
wherein the first source comprises a first piston in a first cylinder and mechanically coupled to a second piston in a second cylinder to be driven by movement of the second piston, the hydraulic areas of the first and second pistons being different, whereby the first piston, in use, delivers fluid at a pressure which differs from the pressure applied to the second piston.

18. Apparatus according to claim 17, wherein the hydraulic area of the first piston is smaller than the hydraulic area of the second piston, whereby the first piston, in use, delivers fluid at a higher pressure than the pressure applied to the second piston.

19. Apparatus according to claim 17, wherein the hydraulic area of the first piston is larger than the hydraulic area of the second piston, whereby the first piston, in use, delivers fluid at a lower pressure than the pressure applied to the second piston.

20. Apparatus according to claim 17, further comprising a second source of pressurised fluid, operable to drive the second piston.

21. Apparatus according to claim 20, wherein the second source is selectively operable to drive the second piston or to provide fluid to the torque wrench, whereby the sources create an advance action and a return stroke of the torque wrench.

22. Apparatus according to claim 20, wherein the first source supplies pressurised fluid to an advance port of the wrench to drive an advance action of the wrench.

23. Apparatus according to claim 20, wherein the second source supplies pressurised fluid to a return port of the wrench, to drive a return stroke of the wrench.

24. Apparatus according to claim 20, wherein the first source supplies pressurised fluid to a return port of the wrench, to drive a return stroke of the wrench.

25. Apparatus according to claim 20, wherein the second source supplies pressurised fluid to an advance port of the wrench, to drive an advance action of the wrench.

26. Apparatus according to claim 24, wherein the second source supplies pressurised fluid to an advance port of the wrench, to drive an advance action of the wrench.

27. Apparatus according to claim 17, wherein the source is operable to deliver pressurised fluid until a predetermined quantity has been delivered and thereafter to stop delivering until a subsequent action is required.

28. Apparatus according to claim 27, wherein the source is operable to receive fluid returned from a torque wrench, between deliveries.

29. Apparatus according to claim 27, wherein the source provides, with the wrench, a closed system for the pressurised fluid.

30. Apparatus according to claim 27, wherein the first piston has a permitted stroke length set to determine the predetermined quantity.

31. Apparatus according to claim 30, wherein limit means are provided to detect the first piston reaching a stroke limit.

32. Apparatus according to claim 30, wherein limit means are provided to detect the first piston reaching two stroke limits defining a stroke length.

33. Apparatus according to claim 30, wherein the first piston has an advance stroke delivering fluid to the wrench, and a return stroke receiving fluid from the wrench.
